(19) United States
(12) Patent Application Publication
(10) Pub. No.: US 2013/0068114 A1
(43) Pub. Date: Mar. 21, 2013

(54) Meat-Pressing Shaper

(71) Applicants: Wen-Hsiu Huang, Chiayi City (TW); Chu-Ho Chen, Chiayi City (TW)

(72) Inventors: Wen-Hsiu Huang, Chiayi City (TW); Chu-Ho Chen, Chiayi City (TW)

(21) Appl. No.: 13/238,079

(22) Filed: Sep. 21, 2011

(51) Int. Cl. A23L 1/025

(52) U.S. Cl. 99/485

(57) ABSTRACT

A meat-pressing shaper has a base, an intermediate plate and a top plate pivotally assembled together. The intermediate plate is conveniently detachably mounted to the base and has convex surfaces at both sides to make the meat sheet be pressed evenly in efficient way. Therefore, the treatment quality of the meat sheet is improved and utility of the meat-pressing shaper becomes convenient.

### BACKGROUND OF THE INVENTION

1. Field of the Invention

The present invention relates to a meat-pressing shaper, and more particularly to a meat-pressing shaper, which makes the meat sheet be pressed into even thickness.

2. Description of Related Art

Meat sheet is usually pressed or punched completely before cooking to make the meat sheet have firm texture, which has better mouthfeel and has more springy in comparison with the one without treatment. In conventional meat treatment, the meat sheet is treated by punching by manpower or pressed by roller machine. When the meat sheet is treated by manpower punching, the treatment processing is slow and inefficiency for mass supply to numerous consumers. If apply more manpower to take the treatment processing, it is uneconomic and causes low competition capability because of the labor cost which is getting higher and higher by days. When the meat sheet is treated by the roller machine, treatment efficiency is improved and the labor cost is reduced but the distance between two rollers is fixed and unable to be adjusted according to different thicknesses of the meat sheets so that the pressing treatment of the meat sheets is uneven and incomplete.

### SUMMARY OF THE INVENTION

A main objective of the present invention is to provide a meat-pressing shaper, which makes the meat sheet be pressed to have even thickness.

The present invention is to provide a meat-pressing shaper comprises:

a base having a upper surface with two ends;
multiple grooves defined on the upper surface;
a first pivotal device formed on one end of the base; and
an abutting post formed on the other end of the base;

an intermediate plate with two surfaces and two ends having
a second pivotal device and a third pivotal device formed on the two ends respectively and selectively engaged to the first pivotal device on the base; and
a first pressing surface and a second pressing surface formed on the two surfaces respectively, wherein the first pressing surface and the second pressing surface each have a convex surface which has one end inclined greater than the other end; and

a top plate pivotally mounted on the intermediate plate and having two ends;
a fourth pivotal device formed on one end of the top plate to engage the intermediate plate and having a hook end to abut the abutting post; and
a pressing handle formed on the other end of the top plate.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a meat-pressing shaper in accordance with the present invention;

FIG. 2 is a lift-up perspective view with the meat-pressing shaper in FIG. 1;

FIG. 3 is an exploded perspective view of the meat-pressing shaper in FIG. 1;

FIG. 4 is an operational perspective view of the meat-pressing shaper in accordance with the present invention;

FIG. 5 is another operational perspective view of the meat-pressing shaper, wherein the meat-pressing shaper is fully extended;

FIG. 6 is an operational cross-sectional side view of the meat-pressing shaper in FIG. 4; and

FIG. 7 is another operational cross-sectional side view of the meat-pressing shaper in FIG. 4.

### DETAILED DESCRIPTION OF THE PREFERRED EMBODIMENT

A meat-pressing shaper in accordance with the present invention has a base, an intermediate plate and a top plate pivotally assembled together. The intermediate plate is conveniently and detachably mounted to the base and has convex surfaces at both sides to make the meat sheet be pressed evenly in efficient way. Therefore, the treatment quality of the meat sheet is improved and utility of the meat-pressing shaper become convenient.

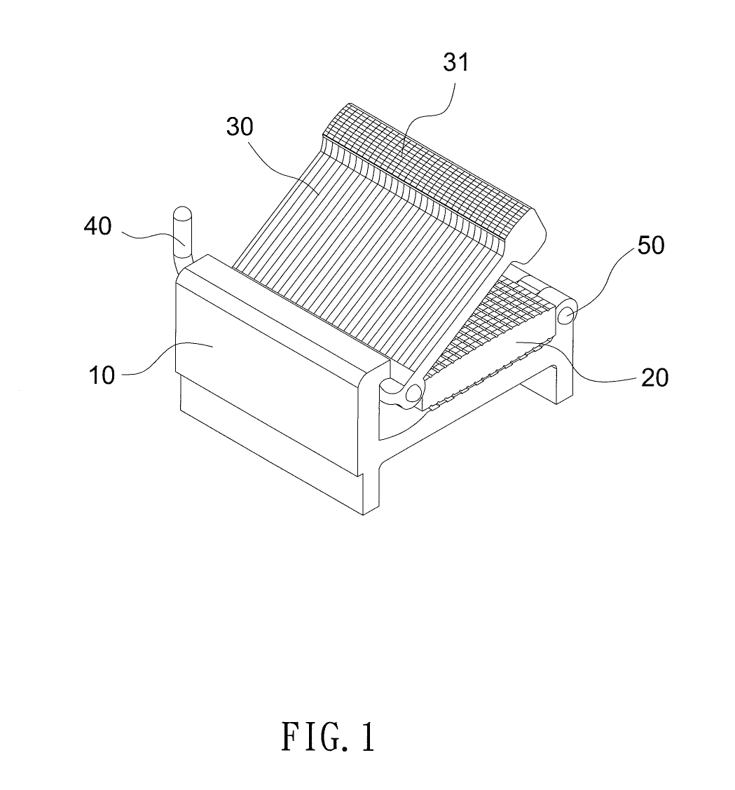

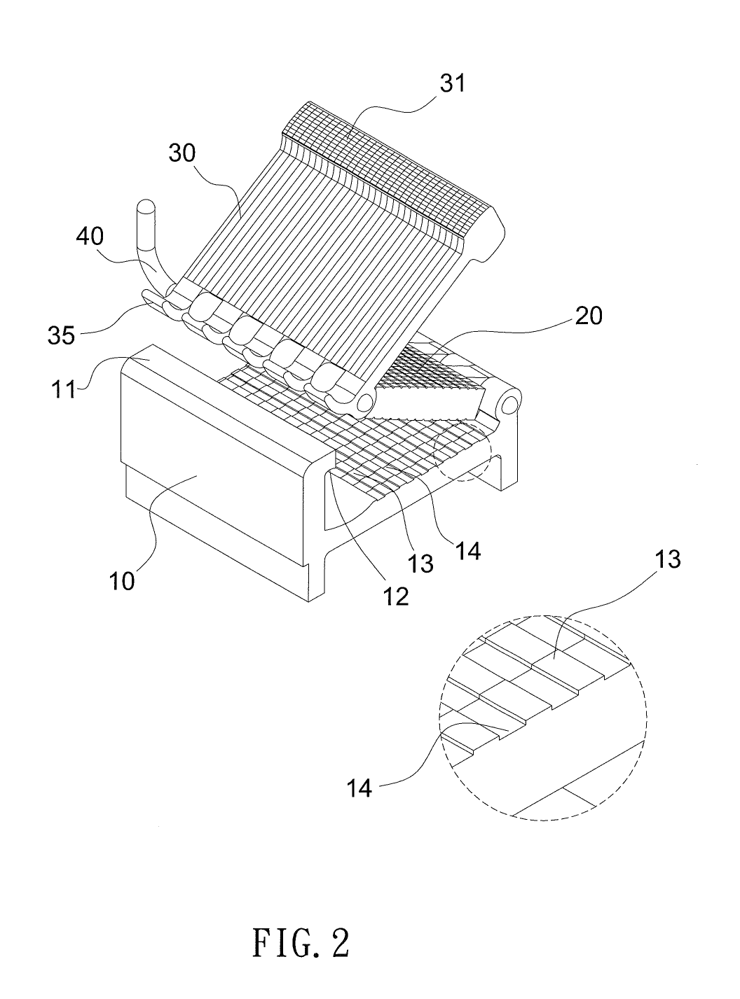

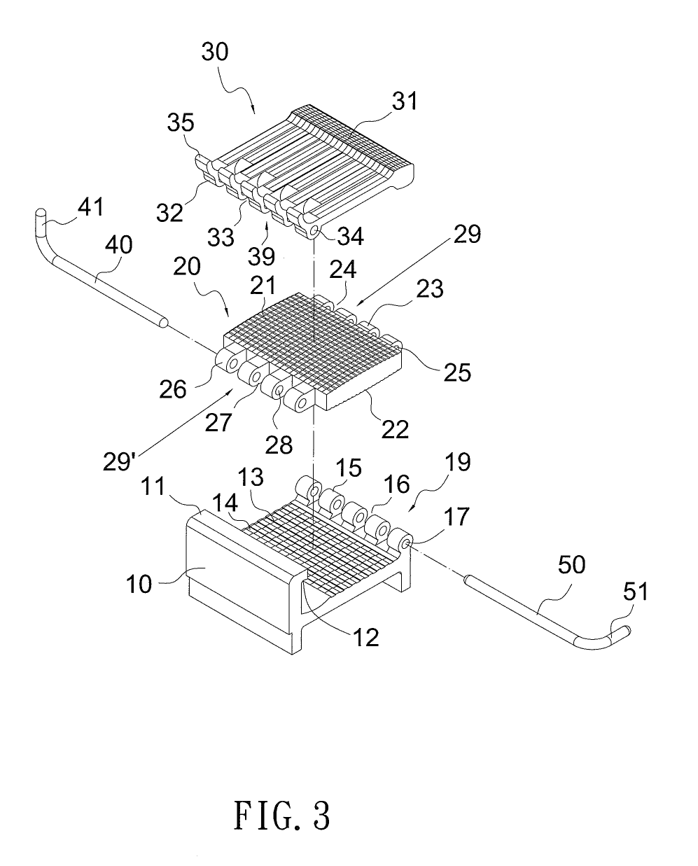

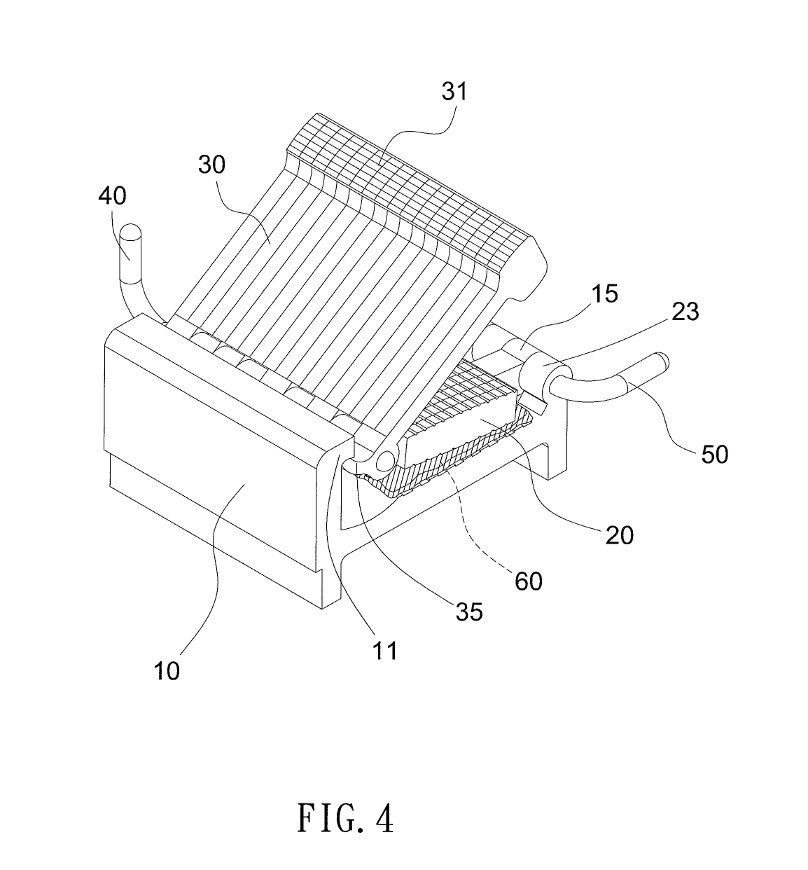

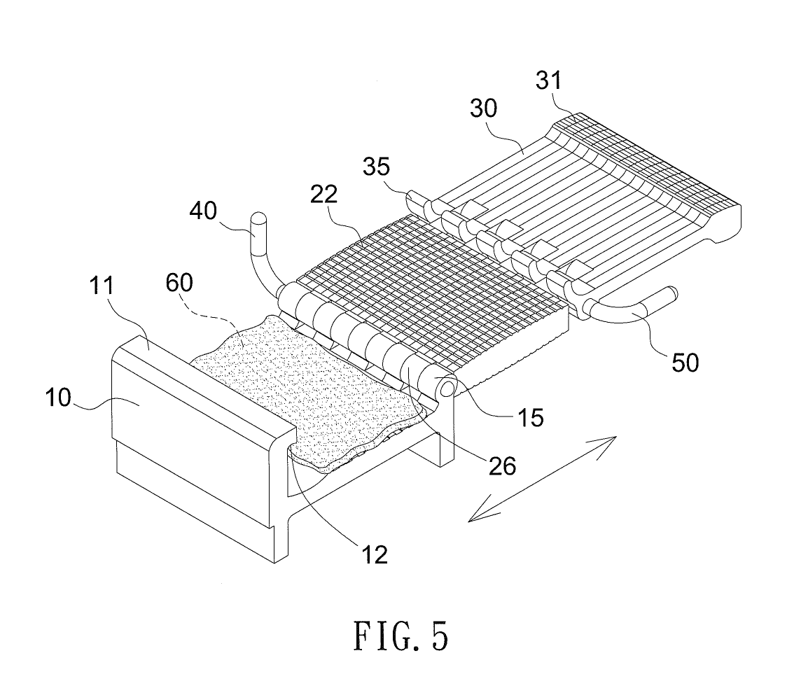

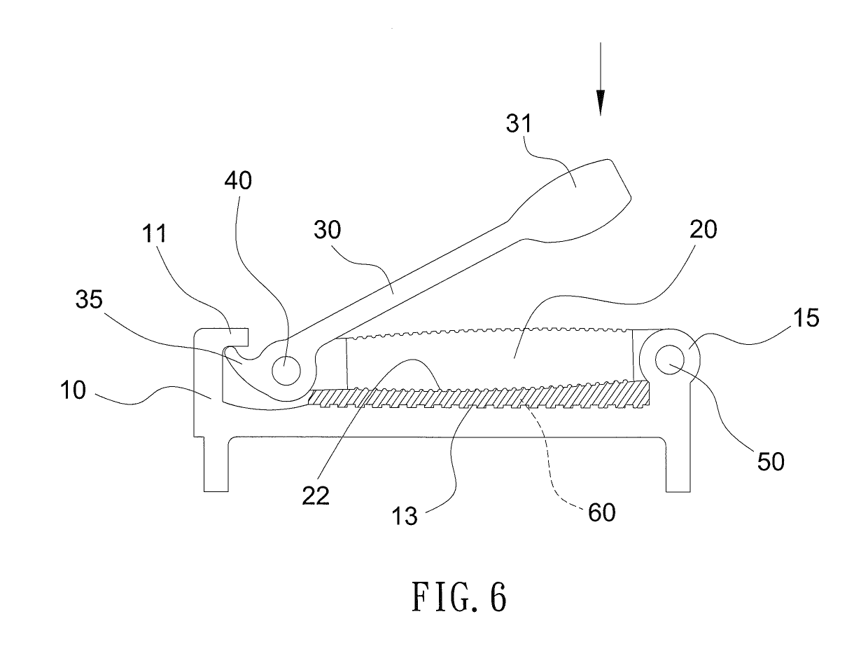

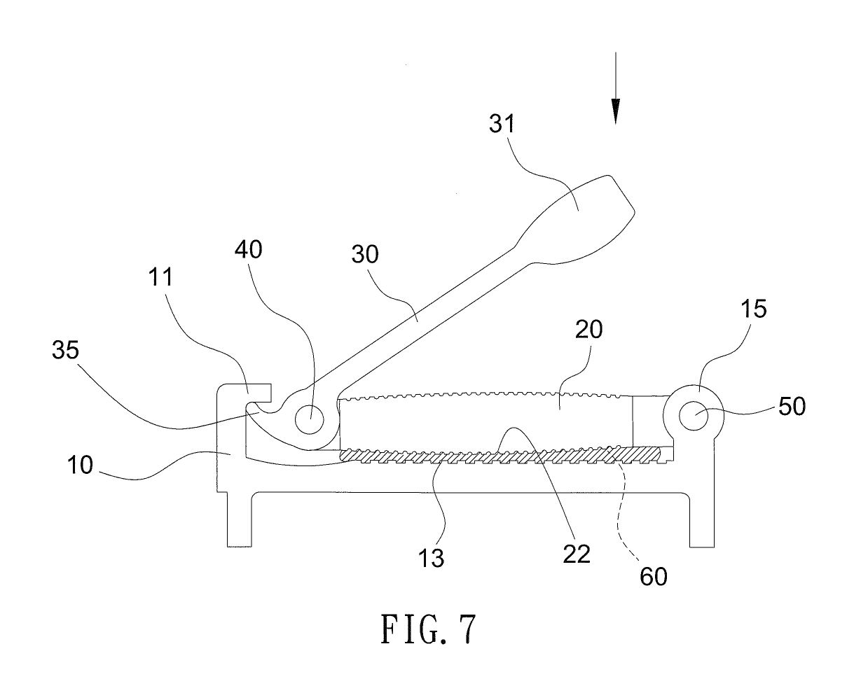

As shown in FIGS. 1 to 7, a preferred embodiment of a meat-pressing shaper is adopted to press a meat sheet 60 to make the thickness of the meat sheet 60 become even. The meat-pressing shaper comprises a base 10, an intermediate plate 20, and a top plate 30.

The base 10 has an upper surface 13 on top and has multiple grooves 14 defined on the upper surface 13 for draining juice of the meat sheet 60 when pressing the meat sheet 60. One side of the base 10 has a first pivotal device 19 composed of multiple first pivot blocks 15 with interval cutouts 16 and the opposite side of the base 10 has an abutting post 11 with a hook distal 12. Each of the multiple first pivot blocks 15 has a first through hole 17 defined laterally to align with the others.

The intermediate plate 20 has a first pressing surface 21 and a second pressing surface 22 on both sides each having a convex surface, wherein the convex surface is unsymmetrical and has one end inclined greater than the other end. The first pressing surface 21 and the second pressing surface 22 are alternatively operated to face the upper surface 13 of the base 10 to make the meat sheet 60 clamped between the intermediate plate 20 and the base 10 to be pressed with different pressures caused by the incline variation of the first pressing surface 21 or the second surface 22 at center and at edge until the meat sheet 60 has even thickness. Two sides of the intermediate plate 20 have a second pivotal 29 device and a third pivotal device 29′ respectively, wherein each of the second pivotal device 29 and the third pivotal device 29′ is composed of multiple second and third pivot blocks 26, 23 with intervals 27, 24 for accommodating the first pivot blocks 15 on the base 10. Each of the multiple second pivot blocks 26 has a second through hole 28 defined laterally to align with others of the multiple second pivot blocks 26. Each of the multiple third pivot blocks 23 has a third through hole 25 defined laterally to align with others of the multiple third pivot blocks 23 and further align with the first through holes 17 on the first pivot blocks 15 of the base 10 to allow a second pivotal rod 50 penetrating the first and third pivot blocks 15, 23. Moreover, the second pivotal rod 50 has a second grip 51 formed at one distal end for easy insertion or withdraw.

One end of the top plate 30 has a fourth pivotal device 39 pivotally engaged the second pivotal device 29 (or the third pivotal device 29′ optionally) on the intermediate plate 20, wherein the fourth pivotal device 39 is composed of multiple fourth pivot blocks 32 with intervals 33 for accommodating the second pivot blocks 26 (or the third pivot blocks 23). Each of the multiple fourth pivot blocks 32 has a fourth through hole 34 defined laterally to align with others of the multiple fourth pivot blocks 32 and further align with the second through holes 28 or third through holes 25 on the intermediate plate 20 to allow a first pivotal rod 40 penetrating the fourth pivot blocks 32 and second or third pivot blocks 26 or 23. Moreover, the first pivotal rod 40 has a first grip 41 formed at one distal end for easy insertion or withdraw. Each of the fourth pivot blocks 32 has a hook end 35 extending upward to operationally abut the hook distal 12 on the abutting post 11 of the base 10. The other end of the top plate 30 opposite to the fourth pivotal device 39 has a pressing handle 31 to facilitate the pushing downward operated by a user.

When the user operates the meat-pressing shaper to press the meat sheet 60 placed on the upper surface 13 of the base 10, the top plate 30 is pivotally pushed downward at the pressing handle 31, meanwhile, the hook end 35 on the top plate 30 rotates to abut the hook distal 12 on the abutting post 11 of the base 10 to provide a counterforce for pressing. Therefore, the first pressing surface 21 or the second pressing surface 22 with the unsymmetrical convex surface evenly presses the meat sheet 60 at two ends, wherein meat juice is drained out via the multiple grooves 14.

When the meat sheet 60 shall be treated by different convex surfaces, the first pivotal rod 40 and the second pivotal rod 50 are withdraw to detach and turn the intermediate plate 20 to switch the first pressing surface 21 and the second pressing surface 22 toward to the upper surface 13 of the base 10. After turning the intermediate plate 20, the second pivot blocks 26 and the third pivot blocks 23 on the intermediate plate 20 are switched to engage the first pivot blocks 15 on the base 10 and the fourth pivot blocks 32 on the top plate 30 respectively.

By having the structure as described in the above embodiment, the meat-pressing shaper of the present invention treats meat sheets 60 with different thicknesses by detaching and turning the intermediate plate 20 optionally. Moreover, pressing treatment by pushing the pressing handle 31 is convenient and energy-saving and sufficient to make the meat sheets 60 shaped to have even thickness.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A meat-pressing shaper comprising:
a base having a upper surface with two ends;
multiple grooves defined on the upper surface;
a first pivotal device formed on one end of the base; and
an abutting post formed on the other end of the base;
an intermediate plate with two surfaces and two ends having
a second pivotal device and a third pivotal device formed on the two ends respectively and selectively engaged the first pivotal device on the base; and
a first pressing surface and a second pressing surface formed on the two surfaces respectively, wherein the first pressing surface and the second pressing surface each have a convex surface which has one end inclined greater than the other end; and
a top plate pivotally mounted on the intermediate plate and having two ends;
a fourth pivotal device formed on one end of the top plate to engage with the intermediate plate and having a hook end to abut the abutting post; and
a pressing handle formed on the other end of the top plate.

2. The meat-pressing shaper as claimed in claim 1, wherein the first pivotal device, the second pivotal device, the third pivotal device and the fourth pivotal device each are composed of multiple pivot blocks with intervals;
wherein each of the multiple pivot blocks has a through hole to align with adjacent ones of the multiple pivotal blocks;
a first pivotal rod penetrating the through holes of the top plate and the intermediate plate when the fourth pivotal device engages the third pivotal device or the second pivotal device; and
a second pivotal rod penetrating the through holes of the base and the intermediate plate when the first pivotal device engages the second pivotal device or the third pivotal device.

3. The meat-pressing shaper as claimed in claim 2, wherein the first to pivotal rod has a first grip; and
the second pivotal rod has a second grip.
